(19) United States
(12) Patent Application Publication
(10) Pub. No.: US 2014/0108123 A1
(43) Pub. Date: Apr. 17, 2014

(54) USER DEFINED POINT-OF-SALE COUPONS AND PAYMENTS

(71) Applicant: MOBEAM, INC., Palo Alto, CA (US)

(72) Inventors: David Russell, Winter Garden, FL (US); John Osborne, Incline Village, NV (US)

(73) Assignee: MOBEAM, INC., Palo Alto, CA (US)

(21) Appl. No.: 14/053,445

(22) Filed: Oct. 14, 2013

Related U.S. Application Data
(60) Provisional application No. 61/714,188, filed on Oct. 15, 2012.

(51) Int. Cl. G06Q 30/02

(52) U.S. Cl. CPC G06Q 30/0238
USPC 705/14.38

(57) ABSTRACT

A system and method for defining a User Defined Coupon (UDC) is provided. In one implementation, a method for defining a UDC includes: identifying a source of funds for the UDC; receiving a user selection of a coupon to apply the funds; and generating the UDC for use at a Point of Sale (POS) terminal for application to a cost of a purchase at the POS terminal. In another implementation, a system for defining a UDC includes: a UDC clearinghouse computer adapted to receive user selection information comprising a source of funds for the UDC and a user selection of a coupon to apply the funds; and generate the UDC for use at a Point of Sale (POS) terminal for application to a cost of a purchase at the POS terminal.

This application claims the benefit of U.S. Provisional Application No. 61/714,188, filed Oct. 15, 2012, the entire contents of which are hereby incorporated by reference.

### BACKGROUND

a. Field

The instant invention relates to a system and method for a shopper to create user defined coupons redeemable on-line or at Point of Sale (POS) terminals.

b. Background

Electronic distribution of coupons has been in use for some time. These coupons are provided by the manufacturer or distributor to temporarily lower costs and induce purchases. The coupons are distributed via printed material or electronically and given some kind of identifier and a fixed value or a value determined at the point of purchase via business rules. In either case it is the manufacturer or retailer who determines the value of the coupon. Merchants usually scan the identifier and using information provided by the coupon owner, then deducts the coupon credit at the Point of Sale (POS) terminal. With electronic distribution of the coupons, significant costs in printing and distribution are avoided. However, most POS terminals use light-reflection based 1-Dimensional scanners to read printed bar codes. This renders redeeming the electronic coupon problematic, as mobile device LED/LCD screens cannot be read by these scanners.

Consumers today have a number of value based accounts of varying types, not just cash, credit cards, debit cards, or checks. These may include “Rewards” Programs from varying manufacturers, distributors, or retailers. They may also include credit card points, on-line trading or barter accounts, auction accounts, or airline miles.

With the ubiquitous availability of mobile devices and the ability of these devices to present light modulated impulses which allow these 1-Dimensional scanners to receive bar codes from the devices, the opportunity exists to create a User Defined POS coupon of any value based on the accumulated wealth of the user's bank and value based “points” accounts.

In US Patent Application 2008/0262928 Michaelis describes a coupon owner that provides coupon redemption information to merchants, and a media agency that provides the coupons themselves to the public. Similarly Fajkowski in US Patent application US2005/0230473 discloses a method and apparatus for coupon management and redemption. In both cases, the starting point of the process is a coupon defined by the manufacturer, distributor, or retail outlet whether physically or electronically. Ramer, et al. U.S. Pat. Nos. 8,195,133, 8,180,332, Wilson et al. U.S. Pat. No. 7,555,444, and Weismantel U.S. Pat. No. 8,126,775 teach how the amount of the coupon can be determined dynamically, but it is still determined by the business logic of the sales side of the transaction. In some cases printers are attached or linked to the mobile phone to create a coupon such as Silverbrook et al. U.S. Pat. No. 8,091,774 but do not disclose the ability of the user to create their own coupon. Evans U.S. Pat. No. 8,091,031 shows a simplified method of creating advertisements including coupons, but this system is again based on the sales side of the transaction.

Similarly the phrase “dynamic incentive” is used in a number of systems such as Shipley US Patent Application 20100257038, Gussoni US Application 20080294512, Gold US Application 20050149392, and Iannacci US Application 20020062249 that describe ways in which business rules, customer selections, and multivariable linear modeling can be utilized to create dynamic coupon valuations, but not user-defined coupons.

To fund a coupon transaction, traditionally the manufacturer or distributor of the item for sale redeems the coupon value with the sales channel. Gatto U.S. Pat. No. 7,954,702 shows one of a myriad of new approaches of aggregating a plurality of financial accounts into one universal financial card and making that value accessible as a coupon via a coupon dispenser, but does not consider the utilization of the mobile device and light beam technology as the delivery mechanism for the value in making electronic payments. Similarly Baig, et al. U.S. Pat. No. 7,941,342 teaches monetary transfers between accounts using a mobile device and a printed coupon as a monetary instrument.

### BRIEF SUMMARY

In one implementation, a user makes or anticipates any generic purchase, such as retail purchases, electronic or on-line purchases, or paying a recurring bill such as a utility bill, debt payment, or contract payment. Once at a physical POS terminal, the user accesses an application on a mobile device that allows the user to enter an amount of a coupon the user wants generated. In various implementations, this amount could be less than, greater than, or equal to the amount of the purchase. A User Defined Coupon (UDC) system then generates an electronically coded barcode which can be presented via the mobile device to the POS barcode scanner, such as by utilizing light beam technology, and the amount of the User-Defined Coupon is automatically deducted from the purchase price, just like any other coupon.

In addition to bank accounts, many users have other accounts of value, such as points or rewards programs, airline miles, auction accounts, and consulting payment accounts. Usually these accounts also have some formula for conversion of points to monetary equivalents. For example a user may “buy” additional airline miles for cash value, or a points program may calculate the value of an item which may be redeemed for the points. Auction account dollar values may be moved between bank accounts, credit card accounts, or other value redemption accounts such as PayPal™.

In one implementation, since previous coupons were redeemed by the manufacturer or distributor, in presenting User Defined POS coupons, a part of a transaction is to define a source of the coupon funds for their redemption. Inasmuch as a generalized clearinghouse for transfer of one value medium for another can be defined, the user may at some time register any or all of his value accounts with the UDC service, and the service would then have those funds available for definition of the coupon. Even without such a clearinghouse, funds from a credit or debit bank account could be called upon for redemption.

In this implementation, the system also utilizes one or more specific merchant identification codes to identify that the coupon presented is coming from the UDC service. This registers the UDC coupon with the merchant's POS system.

A typical barcode system includes two parts, a manufacturer's code and an UPC code Item Number. The Item Number is usually only 5 digits, so while that would be large enough to enter an amount for normal purchases, the exposure to counterfeit barcodes could be problematic. In various implementations, the Item Number could include an encrypted access code that could be used to validate the coupon with the UDC service. The access code could be temporary, invalidated after use or after a period of time so that the code could be reused later, or it could be permanent. In one implementation, a limitation of 5 digits would imply that only 99,999 different codes are available at any given time. The UDC system could create a secondary authentication protocol utilizing additional information from the user's mobile device including but not limited to geographic location, time, amount of coupon, access codes, etc. in the event that two requests generated the same code. The case of two requests generating the same code could also be reconciled via a number of strategies including but not limited to hash table collision resolution, or utilization of multiple manufacturer codes.

In many instances, on-line shopping web sites have coupon or promotional codes that can be entered. If that web site is registered with the UDC service, a user-defined coupon in the form of a promo code could be generated and used for online shopping. If a desktop or mobile device has access to printing resources, a hardcopy barcode coupon could be generated and physically presented at the POS terminal. The coupon could also be pre-defined at one device, and stored at the UDC clearinghouse, and retrieved later by another device for presentation to the POS terminal.

In one implementation, the transaction in the POS system would follow a standard protocol for that system, validating the coupon and then submitting reimbursement requests to the UDC service as if it were any other manufacturer channel.

At the POS terminal the user accesses an application which allows entry of the desired coupon value. This is transferred to the UDC server which encodes/creates the barcode record, and distributes necessary information to the retailer's POS system, possibly a redemption center, and the user's mobile device.

The user can then present the coupon to the POS scanner using the mobile device for redemption, reducing or eliminating the balance of the purchase. The mobile device could also, either independently or via the UDC server, access any existing manufacturer coupons that pertain to the purchase and add this amount so that the best overall discount is obtained. Printed coupons could also be presented in concert or in combination with electronic coupons where allowed.

In another implementation, devices utilizing NFC or other communications could also access the value account in a cardless manner utilizing only the mobile device.

The foregoing and other aspects, features, details, utilities, and advantages of the present invention will be apparent from reading the following description and claims, and from reviewing the accompanying drawings.

### BRIEF DESCRIPTION OF THE DRAWINGS

FIG. 1 shows an example system useful in defining and redeeming a User Defined Point of Sale (POS) Coupon.

FIG. 2 shows a more complex system useful in defining and redeeming a User Defined POS Coupon, including multiple additional features.

FIG. 3 shows an example process of defining a User Defined Coupon (UDC).

FIG. 4 shows an example process of redeeming a UDC.

FIG. 5 shows a general purpose computing system in which one or more components of a User Defined Point of Sale Coupon may execute.

### DETAILED DESCRIPTION

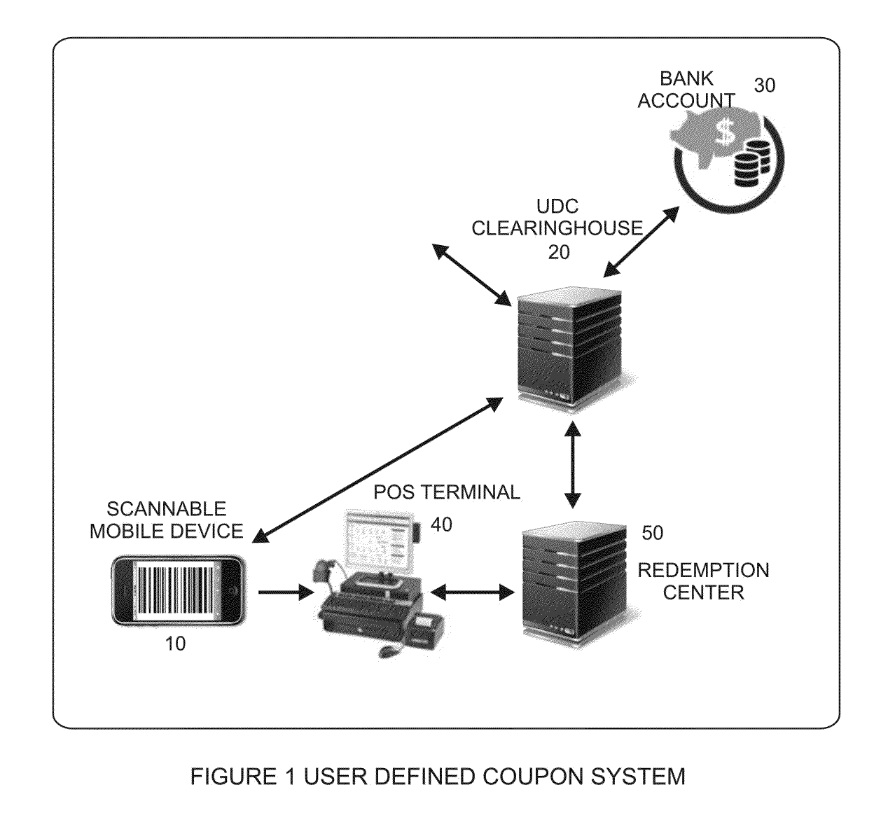

FIG. 1 shows an example system useful in defining and redeeming a User Defined Point of Sale (POS) Coupon. A user's mobile device 10 with a communications link to a UDC Clearinghouse 20 can be used to create the User Defined Coupon (UDC). This system 10 could be, for example but not limited to, a kiosk, desktop computer with Internet access, laptop computer, computing tablet, or mobile phone. The UDC Clearinghouse 20 can be configured by the user in a one-time separate process to register a source of funds, such as a bank account 30 of the user, with the UDC Clearinghouse 20 and to enable the UDC Clearinghouse 20 to access the source of funds. In this way, the user can identify a source of funds for the coupon.

The user can use an application on the mobile device 10 to define the coupon, which can include entering the amount of the desired coupon. If there is more than one source of funds for the coupon available to the user, user can also identify a particular source of the funds for the coupon by entering this information into the application on the mobile device 10. The application would then communicate with the UDC Clearinghouse 20 to generate a coupon in a format readable by the POS system 40. This can include registering that coupon with the UDC Clearinghouse 20 for redemption. That format might be, without limitation, barcode, QR code, or other 1-dimensional or 2-dimensional printed code, or electronic transmission format such as Near Field Communication (NFC) encoding, radio frequency (RF), infra-red (IR), or audio transmission format. The transmission medium between the mobile device 10 and the POS terminal 40 may be any format, protocol, or medium supported by both the device 10 and the POS terminal 40, or between the mobile device 10 and the POS terminal 40 with a third device between them for translation of the format.

In certain embodiments, there can be constraints placed on the user's ability to generate coupons. In this case, a redemption center 50 may communicate these constraints to the UDC Clearinghouse 20 or may respond to inquiries from the UDC Clearinghouse to ensure that the constraints are not violated by the defined coupon.

To fund the redemption of the coupon, the UDC Clearinghouse 20 stores and maintains account information as to the funding sources for the coupon, and has the capability to transfer or request the transfer of funds between itself and the user account 30. An example of an account might be, without limitation, cash, credit, or debit card presented at a coupon kiosk, the user's registered bank account, airline miles or customer loyalty/rewards program, credit card accounts, or other accounts such as eBay™ or PayPal™ accounts, or a consulting payment account such as eLance™. Thus, in addition to or in place of the bank account 30, the user can have access to other accounts of convertible value, such as points or rewards programs, airline miles, auction accounts, and consulting payment accounts. Usually these accounts also have a formula for conversion of points to monetary equivalents. For example a user may “buy” additional airline miles for cash value, or a points program may calculate the value of an item which may be redeemed for the points. Auction account dollar values may be moved between bank accounts, credit card accounts, or other value redemption accounts such as PayPal™. Thus, based on the definition of the coupon provided by the user, the UDC Clearinghouse 20 may convert such a convertible value from one medium, e.g. points, into a second medium, e.g. a monetary value that can be applied to a purchase price.

At a POS terminal 40, the user may present the coupon via the mobile device 110. Multiple coupons may be presented either by the mobile device or printed medium or both. In either case, the POS terminal 40 validates the coupon. Once validated, the coupon amount is then deducted from the purchase price by the POS terminal 40, and the transaction is completed.

Validation of the coupon can be accomplished by the POS terminal 40 sending a validation query the Redemption Center 50 and awaiting confirmation from the Redemption Center 50 that the coupon is valid. In various implementations, an item number could include an encrypted access code that could be used to validate the coupon. The access code could be temporary, invalidated after use or after a period of time so that the code could be reused later, or it could be permanent. In one implementation, a limitation of 5 digits would imply that only 99,999 different codes are available at any given time. The UDC system could create a secondary authentication protocol utilizing additional information from the user's mobile device 10 including but not limited to geographic location, time, amount of coupon, access codes, etc. in the event that two requests generated the same code. The case of two requests generating the same code could also be reconciled via a number of strategies including but not limited to hash table collision resolution, or utilization of multiple manufacturer codes.

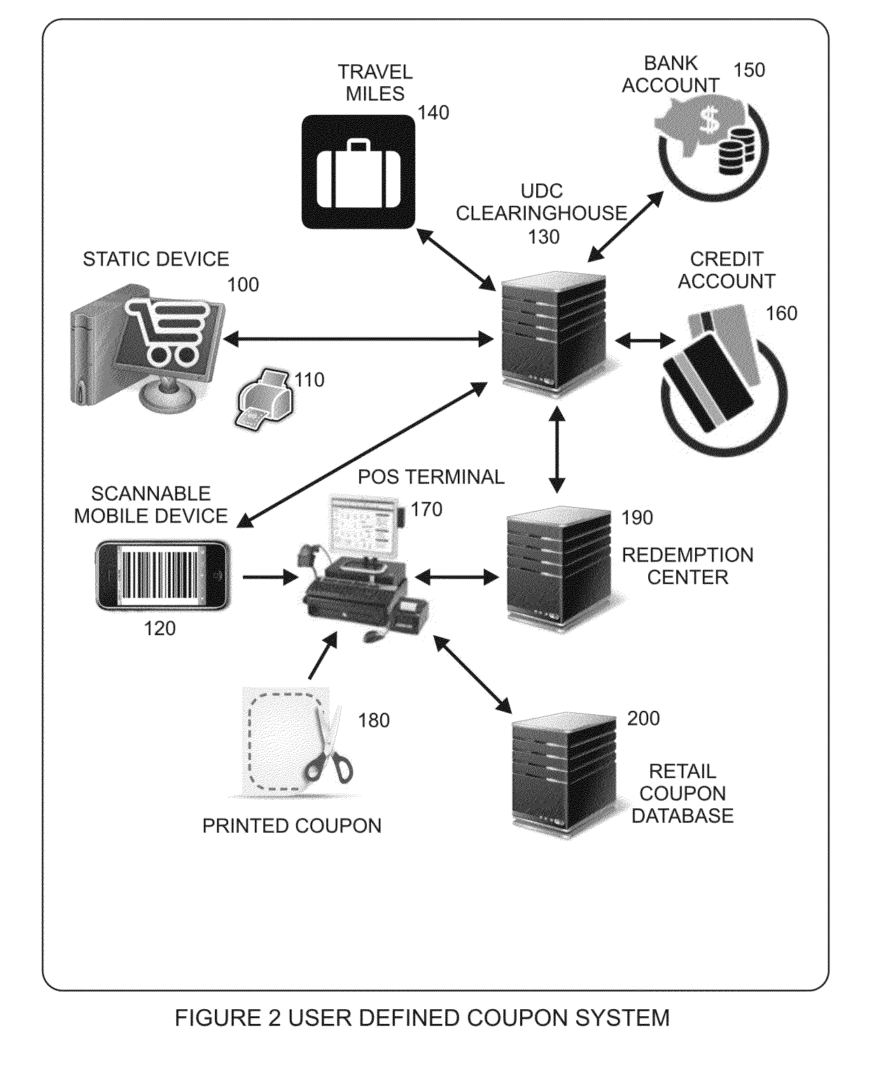

FIG. 2 shows another example system useful in defining and redeeming a User Defined Point of Sale (POS) Coupon. Any desktop or mobile device 100 which has access to a source of funds and a communications link to a UDC Clearinghouse 130 can be used to create the User Defined Coupon (UDC). This system could be, for example but not limited to, a kiosk, desktop computer with Internet access, laptop computer, computing tablet, or mobile phone. If the device has access to some form of printing device 110, hardcopy barcode coupons could also be generated. This would allow the coupon to be redeemed at a retail establishment that might not employ a barcode scanning device or have an electronic Point of Sale (POS) system.

To fund the redemption of the coupon, the UDC Clearinghouse 130 stores and maintains account information as to the funding sources for the coupon, and has the capability to transfer for request the transfer of funds between itself and user accounts or between user accounts. An example of accounts might be, without limitation, cash, credit, or debit card presented at a coupon kiosk, the user's registered bank account 150, airline miles or customer loyalty/rewards program 140, credit card accounts 160, or other accounts such as eBay™ or PayPal™ accounts, or a consulting payment account such as eLance™. In some instances, direct funds transfers from one account may not be available to the UDC Clearinghouse 130, and funds may need to be transferred from one account to another before it can be transferred to the Clearinghouse 130.

In one implementation, the UDC Clearinghouse 130 also maintains connections to one or more Coupon Redemption Centers (CDC) 190. The CDC 190 can act as a redemption and validation source for coupons presented to retailers who use the CDC 190 as a service. The retailer may also have its own Retail Coupon Database (RCD) 200 to which it turns for validation of coupons accepted by the retailer. The UDC Clearinghouse 130 could maintain interconnection with the CDC 190 or RCD 200 or both. A single retailer might also rely upon multiple CDC 190 and RCD 200 services at the same time.

In one implementation, a shopper utilizes a kiosk, desktop, laptop, or mobile device 120 to access a stored application or program on the device and access the UDC Clearinghouse 130 service with a request to generate a coupon. The UDC Clearinghouse 130 validates that the convertible value or funds identified by the user are available and issues the coupon, notifying the CDC 190 and RCD 200 systems of the coupon's validity. The coupon may be stored for later use, presented via a mobile device, such as via light modulated beaming or other communication method, or printed by some device or kiosk for later presentation. Although in some implementations described herein the communication is described as being accomplished via light modulated beaming or other methods, these communication methods are merely examples of communication methods that may be utilized, such as a barcode, RF communication, Bluetooth communication, Near Field Communication (NFC), and the like. Via the Internet, the user may also be provided with other coupons issued by the manufacturer, or a manufacturer's existing coupon redemption center 190 may be polled to provide additional funding for the UDC by the manufacturer or distributor themselves.

At a POS terminal 170, the user may present the coupon via the mobile device 120 or printed coupon 180. Multiple coupons may be presented either by the mobile device or printed medium or both. In either case, the POS terminal 170 queries its CDC 190 or RCD 200 systems, or both, to validate the coupon. The coupon amount is then deducted from the purchase price by the POS terminal 170, and the transaction is completed.

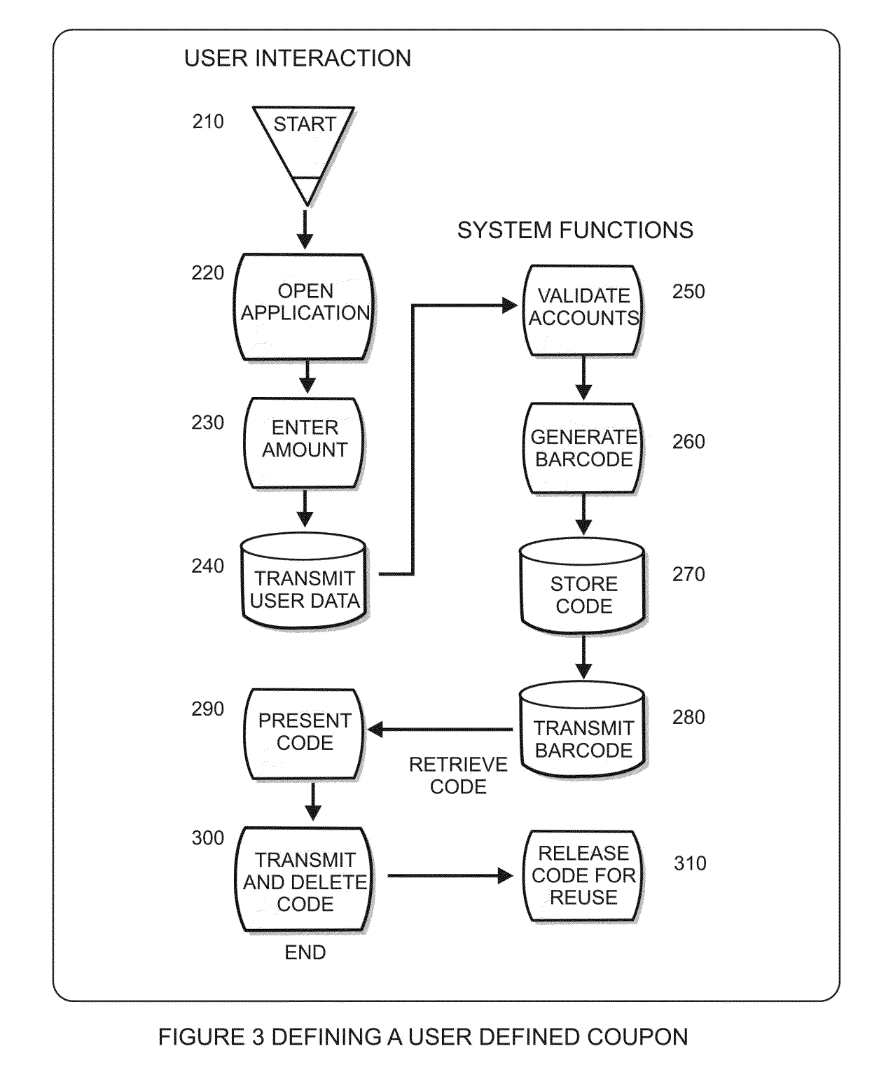

FIG. 3 shows an example process of defining a User Defined Coupon (UDC). A user begins at operation 210 by accessing a UDC application 220 via any computing device with sufficient resources and connectivity to access the UDC Clearinghouse web site or database. This could include but not limited to connectivity via POTS telephone for voice or modem access, Internet connectivity via mobile, hardwired, or optical network, or satellite service. This computing device could be anything from a desktop or mobile computing device to kiosk, ATM terminal, POS terminal, bank teller terminal, Western Union™ station, or Internet connected gaming console.

Once connected to the UDC application and clearinghouse in operation 220, the user would enter the amount of the coupon to be generated in operation 230. This transaction might also include other user-transaction identification encoding such as but not limited to location, Personal Identification Number (PIN) codes, time, mobile device or SIM card ID, or credit or debit card numbers. These additional identifiers may be used to validate a particular coupon transaction in the event that two coupons with the same bar code are active at the same period of time.

The user may also provide information to the clearinghouse application as the amount or priority of accounts which will be referenced to fund the redemption of the coupon, and whether the coupon should be stored for later use, recalled from storage, presented for immediate use, or printed on some device. Other functions of the application may include but not be limited to search for additional manufacturer or distributor coupons, search for the closest retailer stocking an item to be purchased, finding and comparing prices at various retailers, identifying retailers who are connected to the UDC for redemption, or providing maps and directions to find the retailer.

Once all of the required data has been collected by the user's computing device, it is transmitted in operation 240 to the UDC Clearinghouse. This transmission may be in a single block transfer or it may encompass a dialog of requests and user responses that could be different for each transaction. For example, one transaction at off-peak hours may require only the mobile device's identification information, while at peak periods where multiple barcodes with the same encoding might be generated the UDC Clearinghouse may also request additional information via the application. It is also possible that a kiosk-based application may itself be the funding source for the coupon based on cash or credit/debit card information provided to the kiosk by the user.

The UDC Clearinghouse then processes the request in operation 250 by validating the user's registered accounts or value presented at a kiosk, then generates in operation 260 the barcode for the coupon. It is possible that more than one coupon with the same code could be generated. The barcode information is then stored in operation 270 for possible later retrieval and transmitted in operation 280 to the device currently running the application and to the CDC and RCD centers known to the UDC Clearinghouse.

At some point, either immediately upon receipt or at some later time or some other device, the coupon barcode is retrieved from the UDC Clearinghouse. It can be printed if printer capability is available, or presented in operation 290 via Near Field Communication (NFC), visible picture on the mobile device (for 2-D capable scanners) or presented via modulated light beam for 1-D scanners.

The POS terminal then uses this code to validate the coupon, retrieve the amount from the CDC or RCD, and complete the transaction. If the UDC application is active and displaying the code, it may then transmit the coupon usage information in operation 300 to the UDC Clearinghouse and the coupon code may be released for later reuse in operation 310.

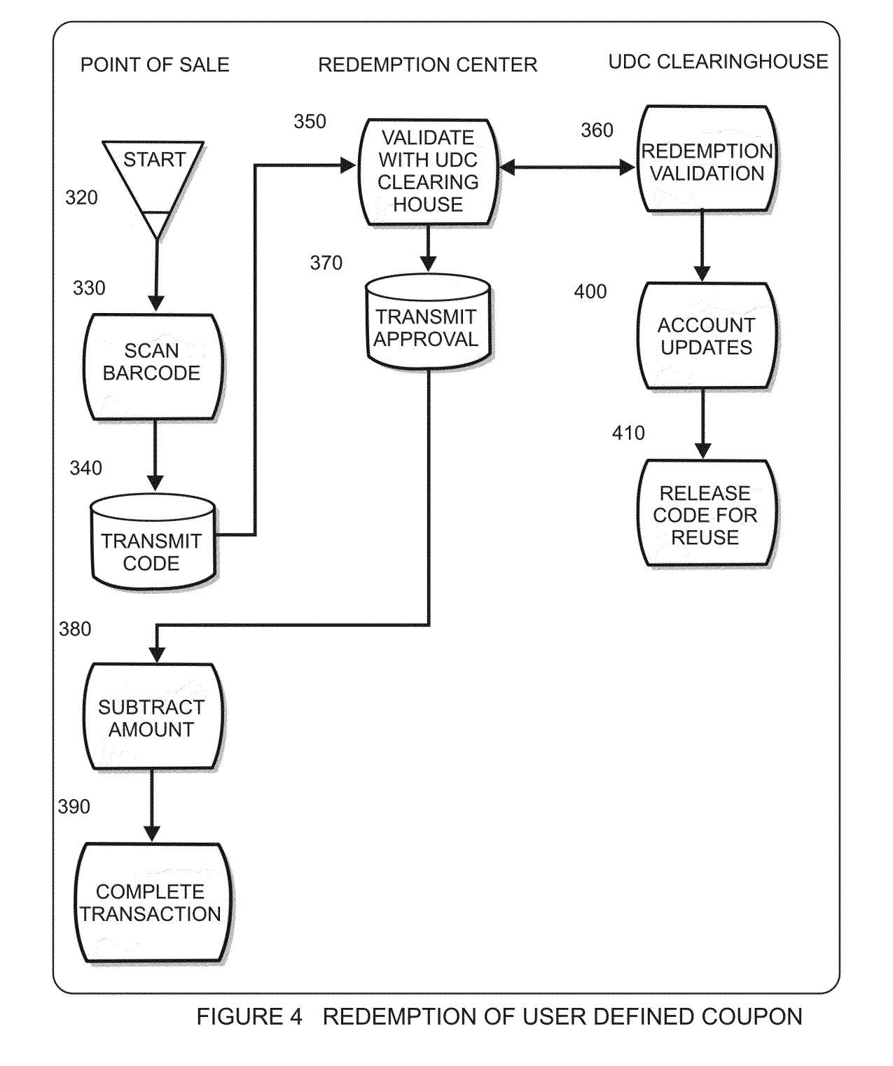

FIG. 4 shows an example process of redeeming a UDC. As in FIG. 3, the process starts in operation 320 with presenting the coupon to the POS terminal via physical or electronic means. The coupon is received electronically or scanned in operation 330 by a 1-Dimensional or 2-Dimensional scanner. The code is then transmitted in operation 340 from the POS terminal to the CDC or RCD systems which are employed to validate the coupon in operation 350.

In some cases, the coupon may already be registered with the validation systems employed by the retailer, and the transaction simply completes as with any other coupon. In other cases, the coupon may not have been registered either because of insufficient time for registration to complete, or because there are multiple coupons with the same barcode. In these cases, the manufacturer code is recognized by the redemption services and the UDC Clearinghouse is queried directly in operation 360 to validate the coupon. The UDC responds with validation, and the redemption service then transmits final approval in operation 370 to the POS terminal. The POS terminal then subtracts the coupon amount from the transaction in operation 380 and the sale is complete in operation 390. The redemption system would then request payment from the UDC Clearinghouse for the coupon, and that amount would be deducted from the user's registered account(s) in operation 400. Upon validation or redemption request, the UDC Clearinghouse would then release the coupon code for reuse in operation 410. This allows either the user of the coupon by the mobile device application, or redemption of the coupon via the redemption services, or both, to release the code for reuse.

### Exemplary Computing System

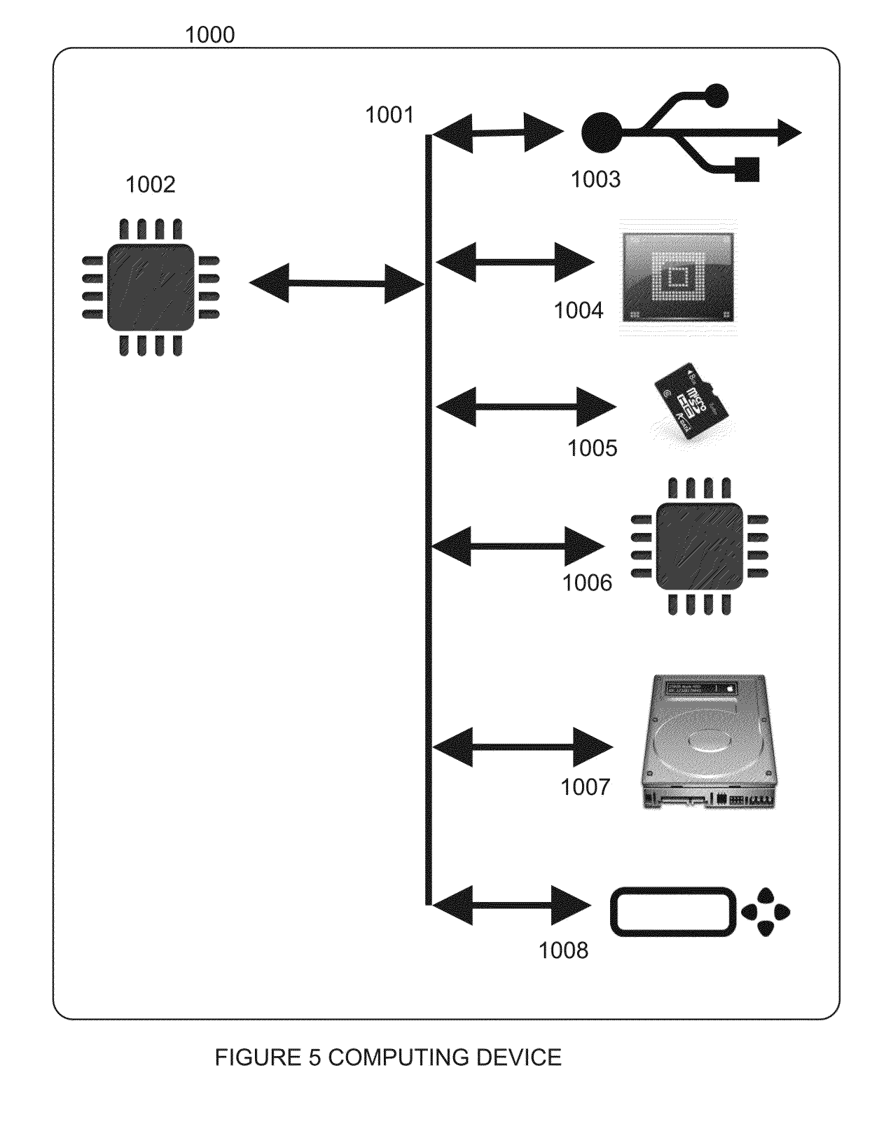

FIG. 5 is a schematic diagram of a computing device 1000 upon one or more components of a User Defined Point of Sale (POS) Coupon creation and redemption system may be implemented. As discussed herein, embodiments of the present invention include various steps. A variety of these steps may be performed by hardware components or may be embodied in machine executable instructions, which may be used to cause a general-purpose or special-purpose processor programmed with the instructions to perform the steps. Alternatively, the steps may be performed by a combination of hardware, software, and/or firmware.

According to the present example, the computing device 1000 includes a bus 1001, at least one processor 1002, at least one communication port 1003, a main memory 1004, a removable storage media 1005 a read only memory 1006, and a mass storage 1007. Processor(s) 1002 can be any know processor, such as, but not limited to, an Intel® Itanium® or Itanium 2® processor(s), or AMD® Opteron® or Athlon MP® processor(s), or Motorola® lines of processors. Communication port(s) 1003 can be any of an RS-232 port for use with a modem based dialup connection, a 10/100 Ethernet port, or a Gigabit port using copper or fiber. Communication port(s) 1003 may be chosen depending on a network such a Local Area Network (LAN), Wide Area Network (WAN), or any network to which the computing device 1000 connects. The computing device 1000 may be in communication with peripheral devices (not shown) such as, but not limited to, printers, speakers, cameras, microphones, or scanners.

Main memory 1004 can be Random Access Memory (RAM), or any other dynamic storage device(s) commonly known in the art. Read only memory 1006 can be any static storage device(s) such as Programmable Read Only Memory (PROM) chips for storing static information such as instructions for processor 1002. Mass storage 1007 can be used to store information and instructions. For example, hard disks such as the Adaptec® family of SCSI drives, an optical disc, an array of disks such as RAID, such as the Adaptec family of RAID drives, or any other mass storage devices may be used.

Bus 1001 communicatively couples processor(s) 1002 with the other memory, storage and communication blocks. Bus 1001 can be a PCI /PCI-X or SCSI based system bus depending on the storage devices used. Removable storage media 1005 can be any kind of external hard-drives, floppy drives, IOMEGA® Zip Drives, Compact Disc—Read Only Memory (CD-ROM), Compact Disc—Re-Writable (CD-RW), Digital Video Disk—Read Only Memory (DVD-ROM).

The implementations of the invention described herein are implemented as logical steps in one or more computer systems. The logical operations of the present invention are implemented (1) as a sequence of processor-implemented steps executing in one or more computer systems and (2) as interconnected machine or circuit modules within one or more computer systems. The implementation is a matter of choice, dependent on the performance requirements of the computer system implementing the invention. Accordingly, the logical operations making up the embodiments of the invention described herein are referred to variously as operations, steps, objects, or modules. Furthermore, it should be understood that logical operations may be performed in any order, unless explicitly claimed otherwise or a specific order is inherently necessitated by the claim language.

The above specification, examples and data provide a complete description of the structure and use of exemplary embodiments of the invention. Since many embodiments of the invention can be made without departing from the spirit and scope of the invention, the invention resides in the claims hereinafter appended. Furthermore, structural features of the different embodiments may be combined in yet another embodiment without departing from the recited claims.

In some implementations, articles of manufacture are provided as computer program products. One implementation of a computer program product provides a transitory or nontransitory computer program storage medium readable by a computer system and encoding a computer program. Another implementation of a computer program product may be provided in a computer data signal embodied in a carrier wave by a computing system and encoding the computer program.

Furthermore, certain operations in the methods described above must naturally precede others for the described method to function as described. However, the described methods are not limited to the order of operations described if such order sequence does not alter the functionality of the method. That is, it is recognized that some operations may be performed before or after other operations without departing from the scope and spirit of the claims.

Although multiple implementations of this invention have been described above with a certain degree of particularity, those skilled in the art could make numerous alterations to the disclosed embodiments without departing from the spirit or scope of this invention. All directional references (e.g., upper, lower, upward, downward, left, right, leftward, rightward, top, bottom, above, below, vertical, horizontal, clockwise, and counterclockwise) are only used for identification purposes to aid the reader's understanding of the present invention, and do not create limitations, particularly as to the position, orientation, or use of the invention. Joinder references (e.g., attached, coupled, connected, and the like) are to be construed broadly and may include intermediate members between a connection of elements and relative movement between elements. As such, joinder references do not necessarily infer that two elements are directly connected and in fixed relation to each other. It is intended that all matter contained in the above description or shown in the accompanying drawings shall be interpreted as illustrative only and not limiting. Changes in detail or structure may be made without departing from the spirit of the invention as defined in the appended claims.

What is claimed is:

1. A method for defining a User Defined Coupon (UDC), the method comprising:
identifying a source of funds for the UDC;
receiving a user selection of a coupon to apply the funds; and
generating the UDC for use at a Point of Sale (POS) terminal for application to a cost of a purchase at the POS terminal.

2. The method of claim 1 wherein the UDC is generated for use on a mobile computing device configured to present the UDC to the POS terminal.

3. The method of claim 1 wherein the source of funds comprises an account registered with a coupon defining system.

4. The method of claim 3 wherein the account comprises at least one or more of the group comprising a bank account, a value account, a reward account, an airline mileage account, a hotel reward account, an auction account, and a consulting payment account.

5. The method of claim 1 wherein the source of funds comprises an account associated with a clearinghouse configured to convert between a first value medium and a second value medium.

6. The method of claim 1 wherein the UDC comprise a barcode identifiable coupon.

7. The method of claim 6 wherein the barcode identifiable coupon comprises a manufacturer code and a UPC code Item Number.

8. The method of claim 1 wherein the mobile device is configured to present the UDC to the POS terminal via light beam technology.

9. The method of claim 1 wherein the mobile device is configured to present the UDC to the POS terminal via an NFC communication.

10. The method of claim 1 wherein the UDC uses at least one merchant identification code.

11. The method of claim 1 further validating the coupon prior to redemption of the coupon.

12. A system for defining a User Defined Coupon (UDC), the system comprising:
a UDC clearinghouse computer adapted to:
receive user selection information comprising a source of funds for the UDC and a user selection of a coupon to apply the funds; and
generate the UDC for use at a Point of Sale (POS) terminal for application to a cost of a purchase at the POS terminal.

13. The system of claim 11 wherein the UDC is generated for use on a mobile computing device configured to present the UDC to the POS terminal.

14. The system of claim 11 wherein the source of funds comprises an account registered with a coupon defining system.

15. The system of claim 13 wherein the account comprises at least one or more of the group comprising a bank account, a value account, a reward account, an airline mileage account, a hotel reward account, an auction account, and a consulting payment account.

16. The system of claim 11 wherein the source of funds comprises an account associated with the clearinghouse configured to convert between a first value medium and a second value medium.

17. The system of claim 11 wherein the UDC comprise a barcode identifiable coupon.

18. The system of claim 16 wherein the barcode identifiable coupon comprises a manufacturer code and a UPC code Item Number.

19. The system of claim 11 wherein the mobile device is configured to present the UDC to the POS terminal via light beam technology.

20. The system of claim 11 wherein the mobile device is configured to present the UDC to the POS terminal via an NFC communication.

21. The system of claim 11 wherein the UDC uses at least one merchant identification code.

22. The system of claim 1 wherein the system is configured to validate the coupon prior to redemption of the coupon.

23. A method of defining a User Defined Coupon (UDC), the method comprising:
opening a UDC application program on a computing device;
inputing a definition of the UDC at the computing device, the definition including a value for UDC;
transmitting the definition of the UDC and transaction information to a clearinghouse;
receiving a barcode and presenting the barcode at a point of sale.

24. The method according to claim 23, further comprising validating an account for the UDC at the clearinghouse and generating the barcode for the UDC at the clearinghouse.

25. The method according to claim 23, further comprising validating and redeeming the UDC upon said presenting the barcode.

26. The method according to claim 25, further comprising releasing the barcode for reuse.

27. The method according to claim 25, wherein said validating comprises sending a validation query to the clearinghouse and receiving a validation response from the clearinghouse.

28. The method according to claim 25, wherein said redeeming comprises subtracting an amount of the coupon from a transaction amount.
